(19) United States
(12) Patent Application Publication
(10) Pub. No.: US 2014/0136960 A1
(43) Pub. Date: May 15, 2014

(54) Content-Aware Scrolling

(71) Applicant: MICROSOFT CORPORATION, Redmond, WA (US)

(72) Inventors: Paul Valentin Borza, Bellevue, WA (US); Vaibhav Girish Parikh, Bothell, WA (US)

(73) Assignee: Microsoft Corporation, Redmond, WA (US)

(21) Appl. No.: 13/675,357

(22) Filed: Nov. 13, 2012

(51) Int. Cl. G06F 17/00

(52) U.S. Cl. 715/247

(57) ABSTRACT

Systems, methods, and computer-readable media are presented regarding a viewport adjustment module that provides content-aware scrolling. A viewport adjustment module receives notice of scrolling by a viewport. A determination is made as to the end position of the viewport where the scrolling will stop. A determination is made as to whether new content displayable in the viewport at the end position will be only partially displayable in the viewport. A determination is made regarding an adjustment amount to the end position of the viewport such that the new content in the viewport is fully displayable in the viewport. The end position of the viewport is adjusted according to the determined adjustment amount.

### BACKGROUND

Nearly all computers are able to store and, at the direction of computer users, manipulate very large files or documents. These documents may be books in electronic form (e-books), spreadsheets, word-processor documents, Web content, to name just a few types. However, while the documents may be large, the capacity to display the content of any one document at any given moment is limited. These limitations are imposed by the size of display screen and the size of the viewport on the display screen dedicated to displaying the content of a file. By way of example, FIG. 1 is a pictorial diagram of an illustrative document 100 having a number of displayable elements (including elements 102-112) as well as an illustrative application window 120 with a viewport 122 that displays a number of the displayable elements (bounded by box 114) of document 100. However, as can be seen, the displayable elements of document 100 that are bounded by box 116 are only partially displayed in the viewport 122.

Given the limited viewing space for large documents, most applications that display content of large documents (such as document 100) to a computer user provide the ability to move or scroll the viewport 122 of content within a document so that the computer user can view all of the content of the document (though, of course, not all of a document's content is presented via the viewport at the same time.) In this illustrative figure, application window 120 includes several user interface controls 124-130 for scrolling the viewport 122 up and down the document 100 (since, in this example, the viewport is able to display the entire width of content in the document.) These user interface controls include scroll buttons 124 and 130 as well as a slider button 126 that can be positioned within the slider field 128 which corresponds to the entire length—up/down—of the document 100. Those skilled in the art will appreciate that the user interface controls identified in FIG. 1 are illustrative only, as these controls are common for computer user interaction with a pointing device (such as a mouse.) For other devices that have different modes of user interaction, such as touch-sensitive devices, some of the controls (e.g., scroll buttons 124 and 130) may or may not be present. In any event, irrespective of the device-specific user interface mechanism, through interaction with various user interface controls, the computer user is able to relocate (scroll) the viewport 122 to various locations throughout the document 100.

More often than not, the size of the viewport for a given application, such as viewport 122, is not well aligned with the display of content within a document resulting in some elements that are only partially displayed. As mentioned above, the elements of document 100 bounded by box 116 are only partially visible in the viewport 122. Partially visible content is a common occurrence with regard to scrolling. Partially visible content is often difficult to understand and the computer user is forced to scroll the viewport to discover the exact nature of the partially visible content.

### SUMMARY

According to aspects of the disclosed subject matter, methods are presented regarding a viewport adjustment module that provides content-aware scrolling. A viewport adjustment module receives notice of scrolling of a viewport. A determination is made as to an end position for the viewport where the scrolling will terminate. A determination is made as to whether new content displayable in the viewport at the end position will be only partially displayable in the viewport. A determination is made regarding an adjustment amount to the end position of the viewport such that the new content in the viewport is fully displayable in the viewport. The end position of the viewport is adjusted according to the determined adjustment amount.

According to aspects of the disclosed subject matter, computer-readable media are presented which bear computer-executable instructions. When executed on a computer system comprising, at least, a processor and a memory, the executed instruction configure the computer to provide a method or process for content-aware scrolling of a viewport. The method/process comprises receiving notice of scrolling of a viewport with regard to displayable content of a document. The end position for the viewport (when the scrolling terminates) is determined. If new content in the viewport at the end position will be only partially displayable in the viewport, an adjustment amount applicable to the end position of the viewport is determined such that the new content is fully displayable in the viewport. The end position of the viewport is adjusted according to the determined amount.

According to still further aspects of the disclosed subject matter, a computer system configured to provide content-aware scrolling is provided. The computer system comprises at least a processor and a memory. Also included in the computer system is a viewport adjustment module that executes on the computer system. Upon receiving notice of scrolling of a viewport, the viewport adjustment module determines an end position for the viewport. An adjustment amount to the end position of the viewport such that new content displayable in the viewport will be fully displayed within the viewport at the end position is determined. The adjustment amount is applied to the end position of the viewport.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a pictorial diagram illustrating an illustrative document having a number of displayable elements as well as an illustrative application window with a viewport that displays a number of the displayable elements of the document;

FIG. 2 is a pictorial diagram illustrating the application window of FIG. 1 in which the new content is scrolled entirely into the viewport upon termination of scrolling;

FIG. 3 is a flow diagram illustrating an exemplary routine for adjusting the location of a viewport within a document such that new content scrolled into the viewport is fully displayable;

FIG. 4 is a pictorial diagram illustrating boundary regions where automatic adjustments to the viewport may be optionally suspended in content-aware scrolling; and

FIG. 5 is a block diagram illustrating an exemplary computing system suitable for implementing content-aware scrolling.

### DETAILED DESCRIPTION

For purposed of clarity, the use of the term “exemplary” in this document should be interpreted as serving as an illustration or example of something, and it should not be interpreted as an ideal and/or leading illustration of that thing. A “viewport” is a defined region on a display device through which corresponding content can be presented. A viewport may be nesting in another viewport which is the case when an application presents content of a document (through a viewport 122 in an application window 120) on the main computer display (another viewport). Through a viewport a computer user is able to view at least a portion of the content to which the viewport corresponds. “Scrolling” is the repositioning of a viewport with respect to the displayable layout of the document. “Scrolling the viewport” and “repositioning the viewport with respect to the displayable layout of the document” should be viewed as being synonymous. As used throughout this document, “new content” refers to the displayable content in a viewport that was most recently scrolled into the viewport. For example, if the viewport is scrolled down toward the bottom of a document, the displayable content at the bottom of the viewport is the new content in the viewport.

As will be appreciated by those skilled in the art, scrolling involves moving a viewport 122 from current location in a document 100 to a new location. In this manner, scrolling is very much like discovery of new content. The content at the current location is the “known” content and the content at the new location is “unknown” content. In this sense, as scrolling involves discovery of unknown content, it is advantageous to the computer user to display the unknown content in its entirety at the expense of showing partial elements of known content. As will be described in further detail below, aspects of the disclosed subject matter are directed to adjusting the position of the viewport 122 with respect to the displayable layout of the document 100 such that newly displayed content is displayed in its entirety in the viewport.

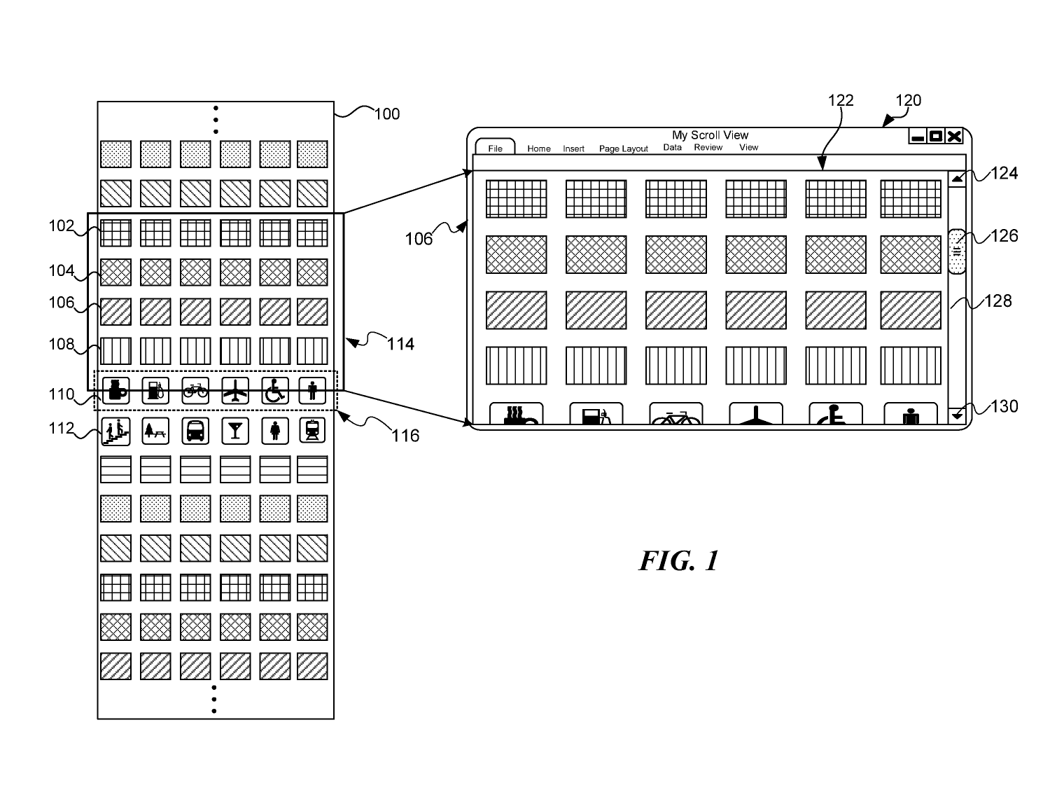

According to aspects of the disclosed subject matter, as a viewport is scrolled with regard to the displayable layout of content, at some point a determination can be made as to where the end position of the viewport will fall. Once the end position of the viewport is known, an examination of the document is made with emphasis on the content being scrolled into the window. Generally speaking, if new content (i.e., content in the document that was not previously displayed within the viewport 122 during the scrolling) would be partially displayed the viewport, the end position of the viewport with respect to the document is adjusted so that the new content will be entirely displayed. To illustrate, we return to the example of FIG. 1.

For purposes of illustration, we can assume that the current position of viewport 122 is the result of a computer user causing the viewport to be scrolled toward the end (bottom) of document 100 such that the displayable elements in box 116 represent the new content to the viewport. According to aspects of the disclosed subject matter, once the end position of the viewport (as a result of the scrolling) is determined, a determination can be made as to whether the new content scrolled into the viewport at the end position will be only partially displayed. If so, an adjustment is made to the terminating/end position of the viewport 122 such that the new content will be completely (or as completely as possible) displayed within the viewport.

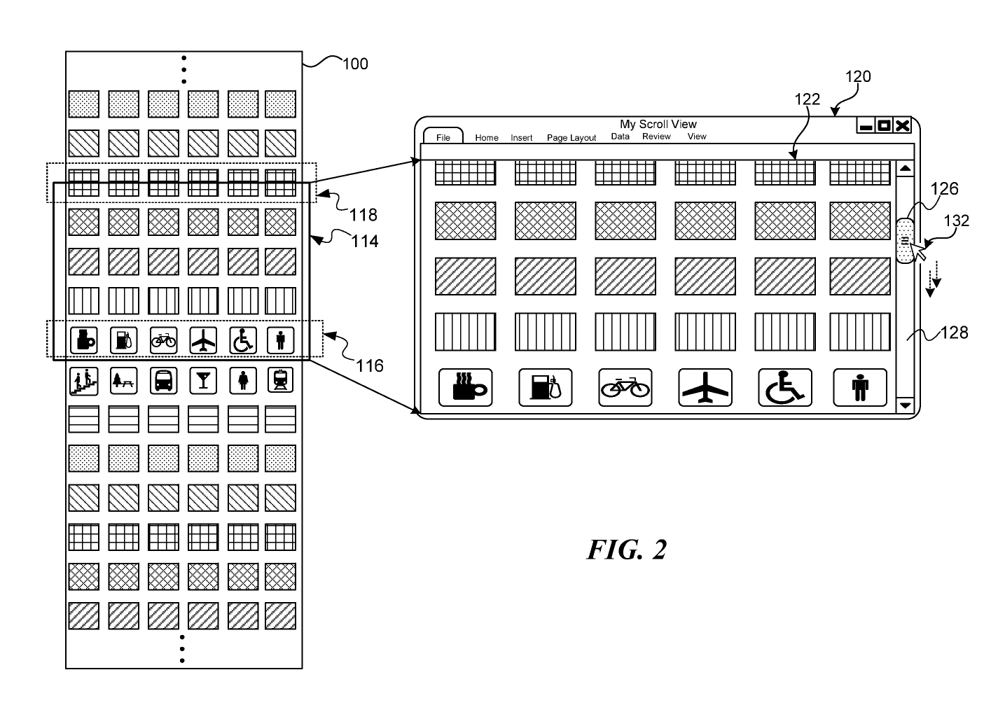

FIG. 2 is a pictorial diagram illustrating the application window 120 of FIG. 1 in which the new content (in box 116 of document 100) is positioned entirely in the viewport 122 upon termination of scrolling. To achieve this, during scrolling and at the point that the end position of the viewport can be determined, a determination is made as to whether new content at the edge of the viewport 122 in the direction of the scrolling activity (e.g., if the viewport is being scrolled to the bottom of the document then the new content is found at the bottom of the viewport) will be displayed in its entirety and, if not, the end position of the viewport with respect to the content of the document is adjusted enough such that the new content will be displayed in its entirety within the viewport. Hence, if the computer user scrolls the viewport 122 down the document 100 by positioning the cursor 132 on the slider button 126 and dragging (i.e., moving the cursor while maintaining an interaction with the slider button) the cursor down toward the bottom of the slider field 128 (as indicated by the directional arrows), once the end position of the viewport can be determined, a determination is made as to whether the new content would be partially displayed in the viewport. If so, an adjustment to the end position of the viewport is made such that the new content in the viewport will be displayable in its entirety (or to the greatest extent possible) in the viewport. In regard to FIG. 2, the displayable elements from box 116 (new content) are displayed in their entirety in the viewport 122 while the displayable elements from box 118 (old/known content) are partially displayed in the viewport.

While the direction of scrolling that is discussed in FIGS. 1 and 2 is a vertical scrolling (i.e., from the top of the document 100 to the bottom of the document), this is for simplicity in illustration only and should not be viewed as limiting upon the disclosed subject matter. Aspects of the disclosed subject matter, and in particular making adjustments to the position of the viewport 122 with regard to the displayable layout of the document 100, may be similarly applied to horizontal scrolling (e.g., scrolling from side to side of the document, or languages that scroll text right to left.) Further still, the adjustments to the position of the viewport at termination of scrolling may be made in multiple directions (up/down, side/side, or in another dimension) in order to display new content in its entirety in the viewport 122. Accordingly, the example of FIGS. 1 and 2 should be viewed as illustrative and not limiting upon the disclosed subject matter.

Further still, for simplicity of display and discussion the content of document 100 is comprised images arranged in rows and columns. However, as previously mentioned the content may be comprised of any number of types or combinations of types. For example, the content may be lines of text, thumbnail images, hyperlinks, icons, combinations of the above, and the like. As will be discussed below, repositioning the viewport 122 at termination of scrolling is content-aware scrolling, meaning that new content is examined according to its type and size such that it (the new content) can be displayed in its entirety in the viewport 122.

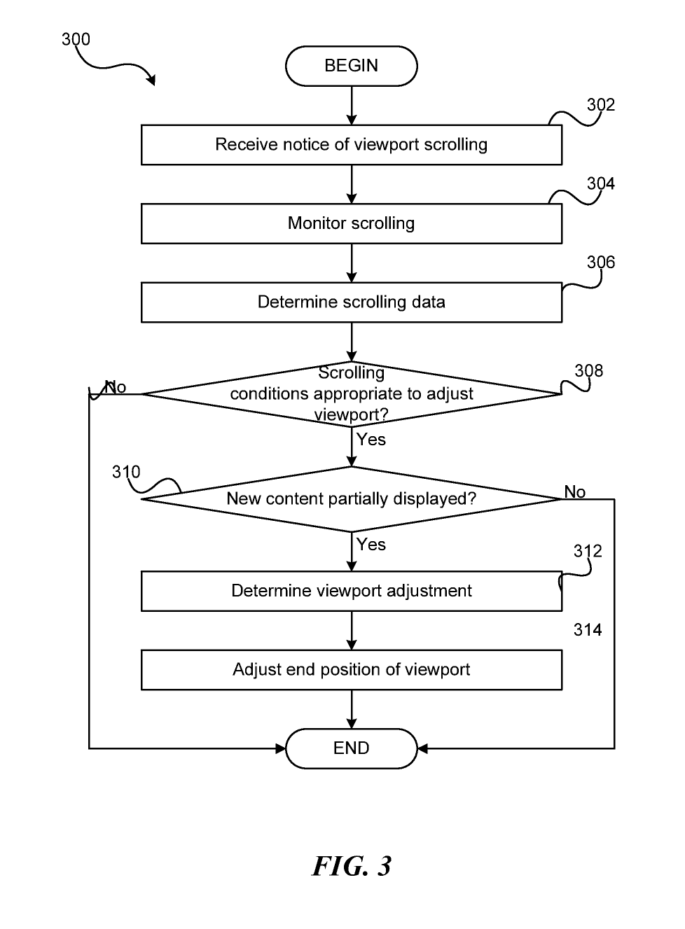

FIG. 3 is a flow diagram illustrating an exemplary routine 300 for adjusting the location of a viewport 122 with regard to the layout of content in a document 100. According to at least one embodiment of the disclosed subject, the routine 300 is implemented as an executable module on a computer system. Beginning at block 302, a notice is received that the viewport 122 is being scrolled. Those skilled in the art will appreciated that this notice comes about through various means (depending on the particular computer system) including subscribing to that type of message, filtering for message of this type, and the like. Upon receiving notice, at block 304 the routine 300 begins to monitor the scrolling (e.g., listening to the scrolling messages).

At block 306, scrolling data is determined. This scrolling data includes an end position for the viewport (i.e., the position with respect to the displayable content where the viewport will be when scrolling terminates), and a scrolling direction (so that the new content can be identified). Regarding the scrolling direction, this is the overall direction of scrolling and may be based on the previous position (before scrolling) of the viewport 122 in contrast to the end position of the viewport. After determining or obtaining the scrolling data, at decision block 308 a determination is made as to whether the scrolling conditions are appropriate to adjust the position of the viewport 122.

There are various factors that may be evaluated in determining whether it is appropriate to adjust the position of the viewport 122 with respect to the display layout of content in a document 100. Of course, one factor is whether new content is or will be partially displayed within the viewport 122 and the termination of scrolling. However, for purposes of this routine, this particular check is set out in regard to decision block 312 below. Another factor that may be considered is the magnitude of change that occurred with regard to the scrolling. For example, a computer user may wish to scroll the viewport 122 only slightly. In this circumstance, adjusting the end position of the viewport 122 would likely frustrate the computer user's efforts. Accordingly, if the magnitude of change in an axis/direction is less than a threshold amount it may be considered inappropriate to adjust the end position of the viewport along that axis (or even in any direction).

Another factor that may be considered in determining whether it is appropriate to adjust the end position of the viewport is whether the computer user scrolls back and forth across content in the document, i.e., an ambiguous scrolling direction. While a direction may ultimately be determined by the end location of the viewport 122 when the scrolling terminates, the fact that the computer user was moving back and forth may be a sign that adjusting the position of the viewport to fully include new content in the viewport would be inappropriate. Another factor may be the speed at which the scrolling occurs. If a computer user were to scroll at a relatively slow rate, even over a substantial distance, this may be an indication of the computer user's desire to control the precise position of the viewport with respect to the displayable content. As such, it may be inappropriate to adjust the end position of the viewport. Hence, if the speed of the scrolling falls below a threshold speed, it may be inappropriate to adjust the end position of the viewport.

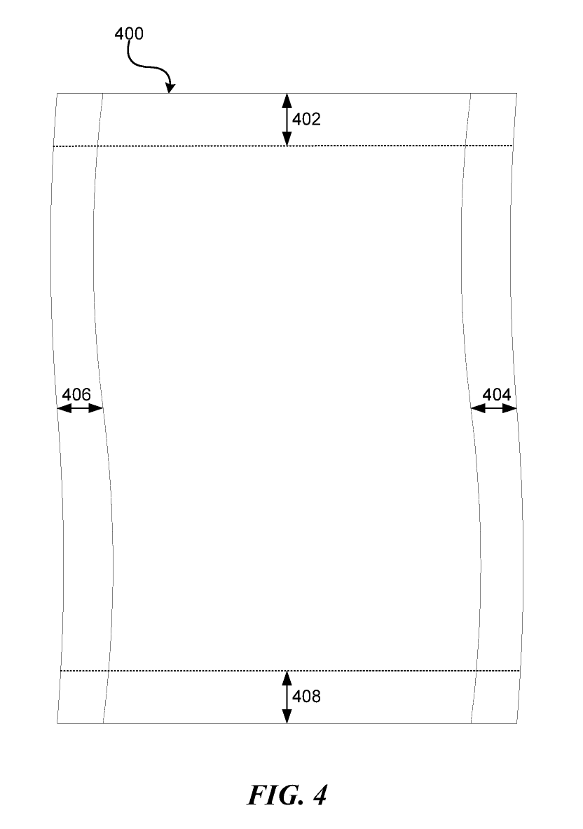

Yet another factor that may be considered when determining whether to adjust the end position of the viewport 122 such that new content is fully displayed within the viewport (or to the extent possible) is whether the viewport falls within or intersects with a predetermined boundary of the content. FIG. 4 is a pictorial diagram illustrating boundary regions of a document 400 where automatic adjustments to the position of the viewport may be optionally suspended (i.e., inappropriate) in content-aware scrolling. More particularly, for the two dimensional layout of the document 400 there are four boundary regions 402-408. Under these conditions, as the position of the viewport 122 moves from a more central position of the document towards and falls within or intersects with one (or more) of the boundaries 402-408, automatic adjustment of the end position of the viewport is suspended (i.e., deemed inappropriate.) In contrast, if the scrolling direction is such that the viewport 122 is moving away from an edge of the document (such as the top edge or left edge of the document 400), adjusting the end position of the viewport may be appropriate to fully display new content in the viewport.

The factors listed above are a few examples that may be considered in regard to whether or not adjusting the end position of the viewport 122 and should not be viewed as limiting upon the disclosed subject matter. In any event, at decision block 308 if the conditions are not appropriate, the routine 300 terminates. Alternatively, if the conditions are appropriate, the routine 300 proceeds to decision block 310. At decision block 310 a determination is made as to whether or not the new content in the viewport 122 will be only partially visible in the viewport. If there is no new content that is partially displayed in the viewport 122, the routine 300 terminates. Alternatively, routine 300 proceeds to block 312.

At block 312, the adjustment amount for the end position of the viewport 122 is determined such that the new content will be fully displayed within the viewport. Generally speaking the adjustment amount will typically be made by the application (or a component of the application) that renders the content of the document via the application window 120. In determining the adjustment amount, the application will need the current position of the viewport 122 so that it can determine what new content is partially displayed as well as what adjustments are appropriate to fully display the new content. This information is then provided to the module that adjusts the position of the viewport 122. To that end, at block 314, the end position of the viewport is adjusted according to the determined amount. Thereafter the routine 300 terminates.

While the majority of the prior discussion has been made in regard to scrolling the position of a viewport 122 (with respect to the display layout of a document 100) in a single direction, those skilled in the art will recognize that scrolling can occur along multiple dimensions. For example, in a two-dimensional display layout of a document (assuming that the viewport is incapable of display either the entire width or height of the document) a user may cause scrolling along both the width and height of the document. Correspondingly, new content may be found along either or both axes. Adjustments to the position of the viewport would be made to fully include (to the extent possible) the new content along both axes. While not shown in the figures, aspects of the disclosed subject matter may be similarly applied to scrolling in three or more dimensions.

As those skilled in the art will appreciate, while the end position of the viewport may be determined when the scrolling stops, adjusting the position of the viewport 122 after the scrolling has stopped could have a visually “jagged” effect. To make the adjustment appear smooth, it is advantageous to determine the end position of the viewport 122 before termination. Since the content is scrolled in a manner to seem fluid and not jerky, is possible to determine the end position of the viewport 122 before the viewport actually stops. For example, on a touch-based input device, the concept of “swiping” causes the viewport to scroll over content at a supplied speed and gradually slow down (resembling the slowing of momentum of the content below). While it may take a few moments for the content to slow, the touch-based device will be able to quickly determine the final end position of the viewport 122 and incorporate the adjustment amounts into the slowing of the scroll such that any adjustment cannot be noticed. Other devices that use pointing devices to scroll may have shorter time frames to determine the end position of a viewport 122 before scrolling comes to an end, but in many cases this can be accomplished. However, even though it may be desirable to determine the end position of the viewport 122 before scrolling has terminated, the disclosed subject matter is not so limited. In various embodiments, the determination of the end position of the viewport 122 is made by obtaining the position of the viewport when scrolling has terminated.

Regarding the routine 300 of FIG. 3, it should be appreciated that while the routine is expressed with discrete steps in carrying out the functionality of adjusting the position of a viewport 122 in regard to the display layout of a document to fully include new content, these steps should be viewed as being logical in nature and may or may not correspond to any actual and/or discrete steps. Nor should the order that these steps are presented in the various, illustrative routines be construed as the only order in which the steps may be carried out. While these steps include novel features of the disclosed subject matter, other steps (not listed) may also be carried out in the execution of routine 300. Further, those skilled in the art will appreciate that logical steps may be combined together or be comprised of multiple steps. Steps of routine 300 may be carried out in parallel or in series. Often, but not exclusively, the functionality of routine 300 is embodied in software (e.g., applications, system services, libraries, and the like) that is executed on computer hardware such as the user computers 102-106 described above.

While novel aspects of the disclosed subject matter are expressed in routines, applications, and/or methods, these aspects may also be embodied in computer-readable media (also referred to as computer-readable storage media). As those skilled in the art will appreciate, computer-readable media can host computer-executable instructions for later retrieval and execution. When executed on a computing device, the computer-executable instructions stored on one or more computer-readable storage devices carry out various steps or methods, including those steps, methods, and routines described above. Examples of computer-readable media include, but are not limited to: optical storage media such as Blu-ray discs, digital video discs (DVDs) compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this document, however, computer-readable media expressly excludes carrier waves and propagated signals.

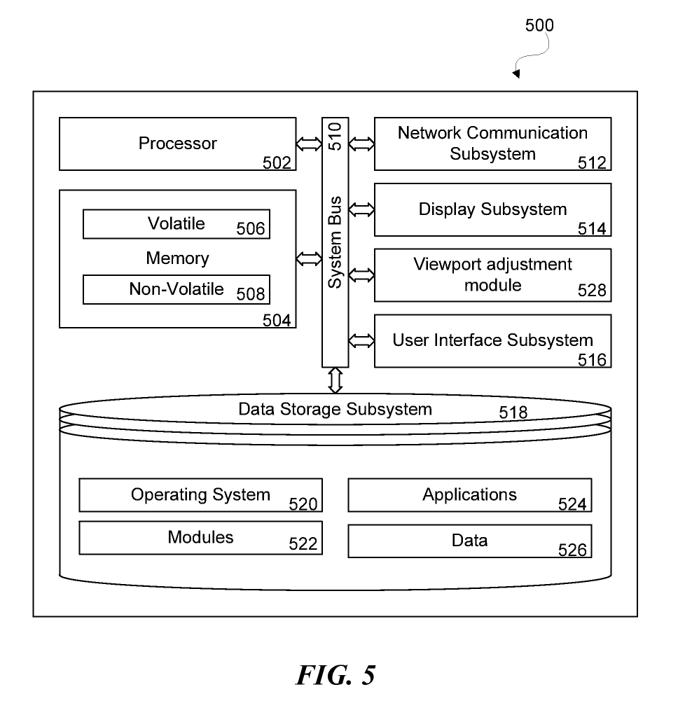

Referring now to FIG. 5, FIG. 5 is a block diagram illustrating an exemplary computer system 500 suitable for providing content-aware scrolling as described above, in particular to adjusting the position of a viewport (in response to scrolling) with regard to the display layout of content of a document to fully display new content scrolled into the viewport. Indeed, FIG. 5 and the following description are intended to provide a brief, general description of a suitable computing system 500 in which the various aspects of the disclosed subject matter can be implemented.

The computing system 500 includes a processor (or processing unit) 502 and a memory 504 interconnected by way of a system bus 510. As those skilled in the art will appreciate, the processor executes instructions retrieved from the memory 504 in carrying out various functions, particularly in adjusting the position of a viewport 122 with regard to the display layout of a document to fully display new content scrolled into the viewport. The processor 502 may be comprised of any of various commercially available processors such as single-processor, multi-processor, single-core units, and multi-core units. Moreover, those skilled in the art will appreciate that the novel aspects of the disclosed subject matter may be practiced with other computer system configurations, including but not limited to: mini-computers; mainframe computers, personal computers (e.g., desktop computers, laptop computers, tablet computers, etc.); handheld computing devices such as smartphones, personal digital assistants, and the like; microprocessor-based or programmable consumer electronics; and the like.

The memory 504 may be comprised of both volatile memory 506 (e.g., random access memory or RAM) and non-volatile memory 508 (e.g., ROM, EPROM, EEPROM, etc.) Moreover, the memory 504 may obtain data and/or executable instructions (especially within the volatile memory 506) from the data storage subsystem 518 by way of the system bus 510. Moreover, a basic input/output system (BIOS) can be stored in the non-volatile memory 508 and conclude the basic routines that facilitate the communication of data and signals between complements within the computing system 500, such as during startup of the computing system. The volatile memory 506 may also include a high-speed RAM such as static RAM for caching data.

The system bus 510 provides an interface for system component's to enter communicate. The system bus 510 can be of any of several types of bus structures that can interconnect the various components (both internal and external components). The computer system 500 further includes a network communication subsystem 512 for interconnecting with other computers and devices on a computer network. The network communication subsystem 512 may be configured to communicate with an external network via a wired connection, a wireless connection, or both.

Also included in the computer system 500 is a display subsystem 514. It is through the display subsystem 514 that the applications (or other executable modules) display content to the computer user. Further still, the computer system 500 includes a user interface subsystem 516 through which the computer system obtains user input. The user interface subsystem 516 provides the interface with various user interface mechanisms including, but not limited to: voice input/output; visual recognition systems; keyboards; touchpads; touch- or gesture-based enabled surfaces (including display surfaces); pointing devices; and the like. As can be seen, many of the user interfaces in which the computer user interacts with the computer (including those for controlling the scrolling of the viewport's position) are included in the user interface subsystem 516. Indeed, while the display subsystem 514 has been individually called out as a separate part of the computer system 500, those skilled in the art will appreciate that in many configurations the display subsystem 514 is part of the user interface subsystem 516.

Further included in the computer system 500 is the viewport adjustment module 528 that is responsible for adjusting the position of the viewport 122 such that new content scrolled into the viewport is displayed in its entirety. In at least one embodiment, the viewport adjustment module 528 implements the content-aware scrolling functionality described above in regard to routine 300 of FIG. 3. In regard to the viewport adjustment module 528, while it is called out as a separate executable component/module of the computer system 500, in various embodiments it may be implemented as a part of the display subsystem 514.

The data storage subsystem 518 provides an additional storage system in addition to the memory 504. Within the data storage subsystem 518 can be found the operating system 520 (for retrieval into memory for execution) of the computer system 500, applications 524 (which may include one or more applications display content on to the computer user); executable modules 522; as well as data 526 which may include content files (such as document 100).

It should be appreciated, of course, that many of the components and/or subsystems described as being part of the computer system 500 should be viewed as logical components for carrying out various functions of a suitably configured computer system. As those skilled in the art appreciate, logical components (or subsystems) may or may not correspond directly in a one-to-one manner to actual components. Moreover, in an actual embodiment, these components may be combined together or broke up across multiple actual components.

Those skilled in the art will appreciate that there may be times that the new content may not be completed displayable in a viewport irrespective of any adjustment. For example, a line of text may be partially displayed both vertically and horizontally. Moreover, while the line of text may be easily scrolled vertically such that the characters of the line that are in the viewport are fully displayed, if the line of text is wider that the viewport there is no amount of adjustment that can be made. In such cases, it would be up to implementation preferences or configurations to determine whether to adjust the line of text to ensure that the ending characters of the line are included in the viewport, adjust the line of text to ensure that the starting characters of the line are included in the viewport, or make no adjustment in a horizontal direction.

While much of the previous discussion has been made in regard to an application having an application window 120 with a viewport 122, it should be appreciated that this is just one embodiment of the disclosed subject matter. A “viewport” should not be viewed as being constrained to an application window 120. For example, the entire display surface of a computing device may be viewed as being a viewport. The entire viewing area of touch devices, such as tablets and smart phones to name just a few, are viewports to apps/applications on the device. A computer user is able to scroll the device's viewport to view content (such as icons for launching apps/applications) that are not currently displayed. The novel aspects of the disclosed subject matter may be suitably applied in this scenario (where the viewport to the app icons is adjusted such that new content in the viewport is displayed in its entirety, even at the expense of partially displaying known content.)

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for content-aware scrolling, the method comprising:
receiving notice of scrolling of a viewport with regard to the displayable layout of a document;
determining an end position for the viewport where the scrolling will terminate;
determining whether new content displayable in the viewport at the end position will be only partially displayable in the viewport;
determining an adjustment amount to the end position of the viewport such that the new content will be fully displayable in the viewport; and
adjusting the end position of the viewport with regard to the displayable layout of the document according to the determined adjustment amount.

2. The computer-implemented method of claim 1, wherein the determined adjustment amount comprises adjustments along a plurality of axes according to the direction of the scrolling of the viewport.

3. The computer-implemented method of claim 1 further comprising determining scrolling data comprising the end position of the viewport.

4. The computer-implemented method of claim 3, wherein the scrolling data further comprises a direction of the scrolling.

5. The computer-implemented method of claim 1 further comprising determining whether it is appropriate to adjust the end position of the viewport such that the new content is fully displayable in the viewport;
wherein adjusting the end position of the viewport with regard to the displayable layout of the document according to the determined adjustment amount comprises adjusting the end position of the viewport with regard to the displayable layout of the document according to the determined adjustment amount when it is determined to be appropriate to adjust the end position of the viewport.

6. The computer-implemented method of claim 5, wherein determining whether it is appropriate to adjust the end position of the viewport is made according to one or more factors including the magnitude of repositioning the viewport as a result of the scrolling.

7. The computer-implemented method of claim 6, wherein the one or more factors includes whether the scrolling had an ambiguous scrolling direction.

8. The computer-implemented method of claim 7, wherein the one or more factors includes the speed of the scrolling.

9. The computer-implemented method of claim 8, wherein the one or more factors includes whether the end position of the viewport intersects with a predetermined boundary region of the display layout of the content and the viewport is advancing toward the boundary of the content in that boundary region.

10. A computer-readable medium bearing computer-executable instructions which, when executed on a computing system comprising at least a processor, carry out a method for content-aware scrolling, the method comprising:
receiving notice of scrolling of a viewport with regard to the displayable layout of a document;
determining an end position for the viewport where the scrolling will terminate;
determining whether new content displayable in the viewport at the end position will be only partially displayable in the viewport; and
determining whether adjusting the end position of the viewport such that the new content will be fully displayable in the viewport is appropriate, and if so:
determining an adjustment amount to the end position of the viewport such that the new content is fully displayable in the viewport; and
adjusting the end position of the viewport with regard to the displayable layout of the document according to the determined adjustment amount.

11. The computer-readable medium of claim 10, wherein the determined adjustment amount comprises adjustments along a plurality of axes according to the direction of the scrolling of the viewport.

12. The computer-readable medium of claim 11, wherein the method further comprises determining scrolling data comprising the end position of the viewport.

13. The computer-readable medium of claim 12, wherein the scrolling data further comprises a direction of the scrolling.

14. The computer-readable medium of claim 10, wherein determining whether adjusting the end position of the viewport such that the new content will be fully displayable in the viewport is appropriate comprises determining whether adjusting the end position of the viewport according to one or more factors including the magnitude of repositioning the viewport as a result of the scrolling.

15. The computer-readable medium of claim 14, wherein the one or more factors further includes a determination as to whether the scrolling had an ambiguous scrolling direction.

16. The computer-readable medium of claim 15, wherein the one or more factors further includes a determination as to whether the speed of the scrolling was below a threshold speed.

17. The computer-readable medium of claim 15, wherein the one or more factors further includes a determination as to whether the end position of the viewport intersects with a predetermined boundary region of the display layout of the content and the viewport is advancing toward the boundary of the content in that boundary region.

18. A computer system for providing content-aware scrolling, the system comprising a processor and a memory, wherein the processor executes instructions stored in the memory as part of or in conjunction with additional components in displaying content on the computer system through a viewport, the additional components comprising:
a display subsystem for presenting content to for viewing to a computer user, wherein the content is presented for viewing to a computer user by way of a viewport;
an executable viewport adjustment module that is configured to adjust the end position of a viewport with respect to the displayable layout of corresponding content such that new content that will be scrolled into the viewport at the termination of scrolling will be fully displayable in the viewport; and
a data storage subsystem that hosts a plurality of executable modules and data, including one or modules configured to present in execution content for display to a computer user via the viewport on the display subsystem;
wherein the viewport adjustment module, in execution on the computing system in conjunction with a module presenting content for display on the computing system via a viewport:
receives notice of scrolling of the position of the viewport with regard to the displayable layout of a document;
determines an end position for the viewport corresponding to the position where the scrolling of the viewport will terminate;
determines whether new content displayable in the viewport and the end position will be only partially displayable in the viewport;
determines an adjustment amount to the end position of the viewport such that the new content will be fully displayable in the viewport; and
adjusts the end position of the viewport with regard to the displayable layout of the document according to the determined adjustment amount upon making a determination that adjusting the end position of the viewport is appropriate.

19. The computing system of claim 18, wherein making a determination that adjusting the end position of the viewport is appropriate comprises making the determination according to one or more factors, including:
the magnitude of repositioning the viewport as a result of the scrolling;
whether the scrolling had an ambiguous scrolling direction;
whether the speed of the scrolling was below a threshold speed; and
whether the position of the viewport intersects with a predetermined boundary region of the display layout of the content and the viewport is advancing toward the boundary of the content in that boundary region.

20. The computing system of claim 19, wherein the determined adjustment amount comprises adjustments to the end position of the viewport along a plurality of axes according to the direction of the scrolling of the viewport.
